(19) United States
(12) Patent Application Publication
(10) Pub. No.: US 2023/0152759 A1
(43) Pub. Date: May 18, 2023

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Kento KOTERA, Kawasaki (JP); Masaaki TAKADA, Abiko (JP); Ryusei SHINGAKI, Setagaya (JP); Ken UENO, Tachikawa (JP)

(73) Assignee: KABUSHIKI KAISHA TOSHIBA, Tokyo (JP)

(21) Appl. No.: 17/898,697

(22) Filed: Aug. 30, 2022

(30) Foreign Application Priority Data
Nov. 17, 2021 (JP) 2021-186893

(51) Int. Cl. G05B 13/04; G05B 13/02

(52) U.S. Cl. CPC G05B 13/041; G05B 13/0265; G05B 13/048

(57) ABSTRACT

An information processing apparatus according to one embodiment includes one or more hardware processors connected to a memory. The hardware processors functions to store, in the memory, history information including identification information of a model and a history of updating the model. The model receives input data including variables and outputs output data. The variables are each a variable for which a rate of influence on the output data is calculated. The model has been updated by using first input data. The hardware processors functions to select a target model to be updated by using second input data. The target model is selected from among models identified by their respective identification information. The hardware processors functions to update the target model by performing transfer learning in which updated parameters are estimated by using the second input data.

### CROSS-REFERENCE TO RELATED APPLICATIONS

This application is based upon and claims the benefit of priority from Japanese Patent Application No. 2021-186893, filed on Nov. 17, 2021; the entire contents of which are incorporated herein by reference.

### FIELD

An embodiment described herein relates generally to an information processing apparatus, an information processing method, and a computer program product.

### BACKGROUND

In some cases of a machine learning model required to be constantly updated, such as a prediction model or an abnormality detection model in a monitoring system for a factory or a plant, stable updating is desired for performing model validation and factor analysis. A technique has been proposed, in which models obtained before updating a model are taken into account in the learning of a machine learning model, whereby the model is stably updated.

Distribution of data obtained from an actual monitoring system may considerably changes unintendedly and temporarily due to changes in the operating conditions of manufacturing facilities, a sensor failure, and/or other factors.

However, conventional techniques do not take into account an extraordinary period in which the distribution of data considerably changes unintendedly and temporarily. Therefore, there is a problem that factors indicated by a model considerably change before and after this period, and thereby validation or factor analysis of a model is made difficult.

### BRIEF DESCRIPTION OF THE DRAWINGS

FIG. 1 is a block diagram of an information processing system according to an embodiment;

FIG. 2 is a diagram illustrating an example of input data;

FIG. 3 is a diagram illustrating an example of parameters of a model;

FIG. 4 is a flowchart of model estimation processing;

FIG. 5 is a flowchart of model updating processing;

FIG. 6 is a flowchart of visualization processing;

FIG. 7 is a diagram illustrating an example of calculated rates of influence;

FIG. 8 is a diagram illustrating an example of estimated inapplicable periods;

FIG. 9 is a diagram illustrating an example of a display screen displaying visualization information; and

FIG. 10 is a hardware configuration diagram of an information processing apparatus according to the embodiment.

### DETAILED DESCRIPTION

An information processing apparatus according to an embodiment includes one or more hardware processors. The hardware processors are configured to function as a storage controller, a selection unit, and an updating unit. The storage controller serves to store, in the memory, one or more pieces of history information each including identification information of a model and a history of updating the model. The model is configured to receive a piece of input data including variables and output a piece of output data. The variables are each a variable for which a rate of influence on the output data is calculated. The model has been updated by using one or more pieces of first input data. The selection unit serves to select a target model to be updated by using second input data. The target model is selected from among models identified by their respective identification information included in the one or more pieces of history information. The updating unit serves to update the target model by performing transfer learning in which updated parameters are estimated by using the second input data.

The following describes a suitable embodiment of the information processing apparatus according to the present invention in detail with reference to the accompanying drawings.

The information processing apparatus according to the present embodiment has, for example, the following functions. With the functions, it is possible to achieve easier model validation and factor analysis even when there is an unintended and temporary considerable changes in the distribution of data.
a function to store models previously updated and an update history (a learning history)
a function to calculate an evaluation value of each of the stored models by using new data
a function to select the most appropriate model from among the stored models and set the selected one as a model to be updated
a function to determine a period in which accidental data is obtained temporarily

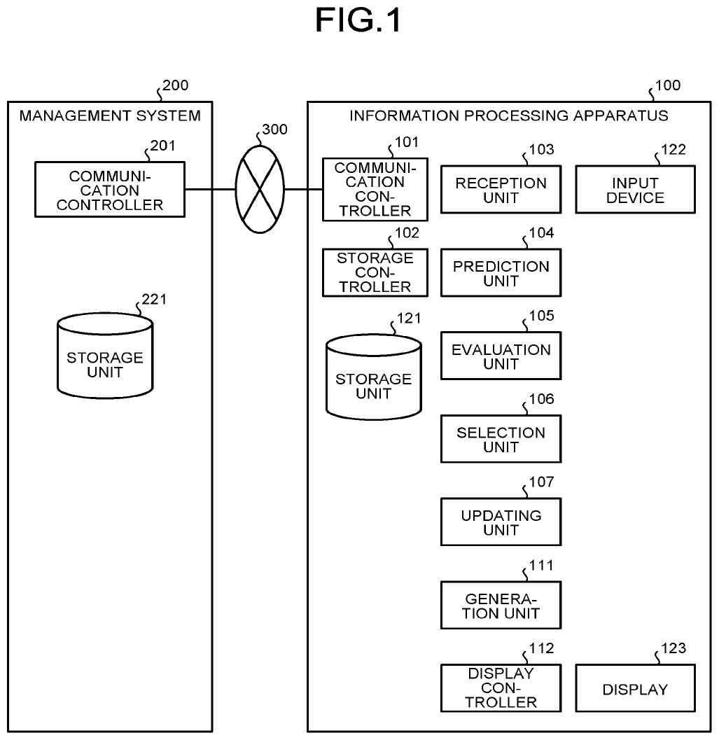

FIG. 1 is a block diagram illustrating an example of the configuration of an information processing system including the information processing apparatus according to the present embodiment. As illustrated in FIG. 1, the information processing system has a configuration in which an information processing apparatus 100 and a management system 200 are connected via a network 300.

The information processing apparatus 100 and the management system 200 can each be configured as, for example, a server apparatus. The information processing apparatus 100 and the management system 200 may be implemented as physically independent multiple apparatuses (systems) or may be configured separately as functions of these apparatuses (systems) in a single physical apparatus. In the latter case, the network 300 may be omitted. At least one of the information processing apparatus 100 and the management system 200 may be built on a cloud environment.

The network 300 is a network such as, for example, a local area network (LAN) or the Internet. The network 300 may be either a wired network or a wireless network. The information processing apparatus 100 and the management system 200 may transmit and receive data to and from each other using a direct wired or wireless connection between components without using the network 300.

The management system 200 is a system that manages a model to be processed by the information processing apparatus 100 and data to be used for learning (estimation) for and analysis of the model. The management system 200 has a storage unit 221 and a communication controller 201.

The storage unit 221 stores various kinds of information used in various kinds of processing that are performed by the management system 200. For example, the storage unit 221 stores data such as input data that is used to estimate the model. The storage unit 221 can include any commonly used storage medium, such as a flash memory, a memory card, a random access memory (RAM), a hard disk drive (HDD), or an optical disk.

The model is configured to output a piece of output data (an objective variable) being an inference result in response to receiving a piece of input data including multiple variables (explanatory variables). The model is a machine learning model to be trained (updated) through machine learning using input data for learning. Each of the variables is a variable for which the rate of influence on the output data is calculable. The model is, for example, a linear regression model, a polynomial regression model, a logistic regression model, a Poisson regression model, a generalized linear model, or a generalized additive model. The model is not limited to these ones.

The model is estimated as a result of learning using input data including the objective variable and the explanatory variables. The objective variable is, for example, quality properties, a defect rate, or information indicating whether a product is non-defective or defective. The explanatory variables are, for example, values of other sensors, setting values such as machining conditions, and control values.

The communication controller 201 controls communication with external devices such as the information processing apparatus 100. For example, the communication controller 201 transmits input data to the information processing apparatus 100.

The communication controller 201 is implemented by, for example, one or more hardware processors. For example, the communication controller 201 may be implemented such that a hardware processor like a central processing unit (CPU) executes a computer program, that is, implemented by software. Alternatively, the communication controller 20 may be implemented by a hardware processor such as a dedicated integrated circuit (IC), that is, implemented by hardware. The communication controller 201 may be implemented by a combination of software and hardware. When two or more processors are used, each processor may implement a different one of functions of the communication controller 201 or implement two or more of the functions.

The information processing apparatus 100 includes a storage unit 121, an input device 122, a display 123, a communication controller 101, a storage controller 102, a reception unit 103, a prediction unit 104, an evaluation unit 105, a selection unit 106, an updating unit 107, a generation unit 111, and a display controller 112.

The storage unit 121 stores various kinds of information used in various kinds of processing that are performed by the information processing apparatus 100. For example, the storage unit 121 stores parameters of the model updated by the updating unit 107 and the learning history of the updated model. The storage unit 121 can be constructed of any commonly used storage medium such as a flash memory, a memory card, a RAM, an HDD, and an optical disk.

The input device 122 is a device to be used by a user or the like for inputting information. The input device 122 is, for example, a keyboard or a mouse. The display 123 is an example of an output device that outputs information. The display 123 is, for example, a liquid crystal display. The input device 122 and the display 123 may be integrated in the form of a touch panel, for example.

The communication controller 101 controls communication with external devices such as the management system 200. For example, the communication controller 101 receives input data and other data from the management system 200.

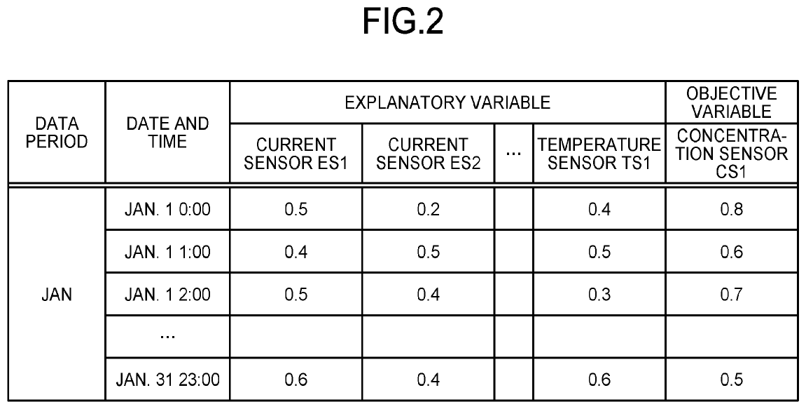

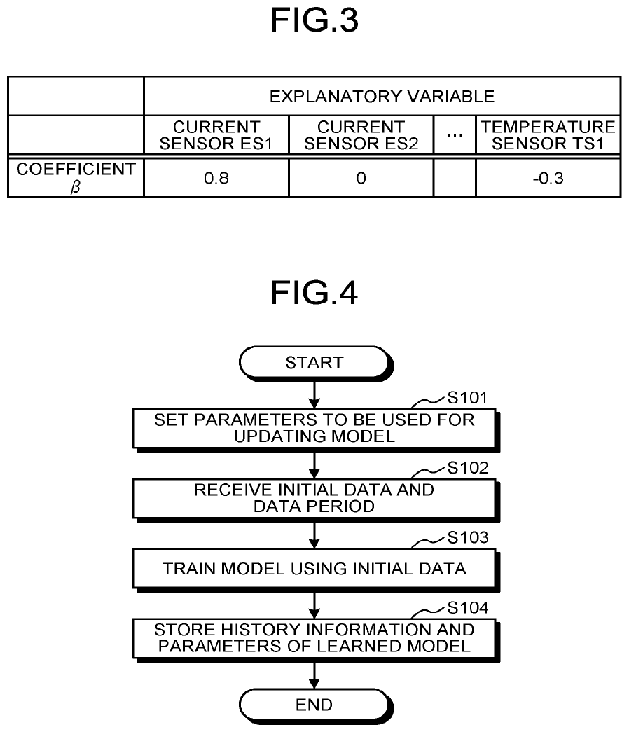

FIG. 2 illustrates an example of the input data. The input data includes a data period, dates and times, the explanatory variables, and the objective variable. The data period indicates a time period (a range of dates and times) in which a corresponding set of data (the explanatory variables and the objective variable) is acquired. The dates and times each indicate date and time when the corresponding set of data is acquired. As illustrated in FIG. 2, the input data can include two or more explanatory variables. Returning to FIG. 1, the storage controller 102 stores parameters of updated models in the storage unit 121. FIG. 3 illustrates an example of parameters of a model. The model illustrated in FIG. 3 is an example of a regression model that has, as parameters, coefficients f3 by which the corresponding explanatory variables are multiplied.

Returning to FIG. 1, the storage controller 102 further stores one or more pieces of history information in the storage unit 121. Each piece of the history information includes identification information of a model updated by using one or more pieces of input data (first input data), and also includes the learning history on this model.

Each piece of the history information is expressed by, for example, a pair (M, H) of a model M and the learning history on the model M. “M” is an example of the identification information of a model. In the following, a model identified by identification information M may be referred to as a model M.

The learning history is information indicating which of models estimated or updated in the past has been updated to obtain the model M. The learning history is expressed by, for example, a history of data periods corresponding to the input data used for the updating. Expression of the learning history is not limited to this example. The learning history may be expressed by, for example, a history of the identification information of models (target models) that have been updated. The learning history may include both the history of the data periods and the history of the identification information of the target models.

The storage controller 102 stores a set S={(M₁, H₁), . . . , (M_{N}, H_{N})} in the storage unit 121. The set S is, for example, a set of pieces of the history information corresponding to the 1st to the Nth updating (N is an integer larger than or equal to 2). The storage controller 102 reads out history information from the storage unit 121 and writes history information in the storage unit 121 as necessary when selecting a target model to be undated next and when updating (training) a model using the selected target model.

The reception unit 103 receives input of various types of information. For example, the reception unit 103 receives a plurality of pieces of input data received from the management system 200 via the communication controller 201 and the communication controller 101. Each piece of the input data includes, for example, data D=(X, Y) consisting of a pair of an explanatory variable X and an objective variable Y, and a data period h indicating a period in which the data D is acquired. When two or more explanatory variables are used, the explanatory variable X can be interpreted, for example, as expressing a vector that has a corresponding explanatory variable as an element.

The reception unit 103 inputs the input data D and the data period h to the prediction unit 104 and the updating unit 107. The data D input to the prediction unit 104 is used for predicting the objective variable for each model in the history information. The updating unit 107 updates (trains) parameters of the target model by using, for example, the data D and the data period h.

The prediction unit 104 predicts the objective variable by using the input data D (second input data) for each of the one or more models identifiable by the identification information contained in the history information. For example, for each of the models M₁, . . . , and M_{N} included in the history information in the storage unit 121, the prediction unit 104 predicts respective predicted values Y\hat{ } of the objective variable Y that corresponds to the explanatory variable X.

The evaluation unit 105 obtains, by using the predicted value Y\hat{ } predicted by the prediction unit 104, evaluation values that represent the degrees of accuracy of the prediction of the individual models. The evaluation value is used by the selection unit 106 to select the target model to be updated.

For example, for each of the models (M₁, . . . , M_{N}), the evaluation unit 105 calculates, as the evaluation value, the mean square error from the objective variable Y and the predicted value Y\hat{ } obtained by the prediction unit 104. The evaluation values are not limited to the mean square errors and may be values calculated on the basis of another criterion, for example, coefficients of determination and mean absolute errors. The respective evaluation values calculated for the models are input to the selection unit 106.

The selection unit 106 selects the target model to be updated from the models included in the history information. For example, the selection unit 106 selects, as a target to be updated, a model whose evaluation value indicates that the model has higher prediction accuracy than the other models.

In a case where the evaluation values are mean square errors or mean absolute errors, the selection unit 106 selects, as the target model, a model whose evaluation value is the smallest. In a case where the evaluation values are decision coefficients, the selection unit 106 selects, as the target model, a model whose evaluation value is the largest. The following denotes the selected target model as M_{best} and the learning history corresponding to the target model M_{best} as H_{best}.

The updating unit 107 performs model updating. The updating unit 107 updates a model by carrying out transfer learning using previously trained models in the second and subsequent learning. In the initial training, no previously trained models exist, so that the updating unit 107 trains a model at the initial training by a method that does not use previously trained models.

For example, the updating unit 107 uses the target model selected by the selection unit 106 as initial values and updates parameters of the target model by transfer learning in which parameters of a model are estimated using the input data D. More specifically, the updating unit 107 updates a model by performing transfer learning using the model M_{best} input from the selection unit 106 and the data D input from the reception unit 103. The updated model is denoted as M_{new}. The updating unit 107 adds, to the learning history H_{best}, the data period h input from the reception unit 103 and thereby obtains H_{new}. The updating unit 107 causes the storage controller 102 to store the updated model and the history information (M_{new}, H_{new}) in the storage unit 121.

The updating unit 107 may preset learning parameters (hyper parameters) to be used in training (updating) models, and also preset a threshold value (the maximum number of models) that indicates the maximum number of models to be stored in the storage unit 121. The maximum number of models is used for, for example, managing storage areas of the storage unit 121 by the storage controller 102.

The storage controller 102 may include a function to delete part of the history information stored in the storage unit 121 in accordance with a predefined condition. For example, the storage controller 102 performs deletion processing after updating a model so as to avoid storing too many models in the storage unit 121. In the deletion processing, the storage controller 102 inputs the set S={(M₁, . . . , (M_{N}, H_{N})} of history information stored in the storage unit 121. When the size of the set S (the number of pieces of the history information in the set S) exceeds the maximum number of models (an example of the condition), the storage controller 102 deletes the oldest piece (M₁, H₁) of the history information. The storage controller 102 stores, in the storage unit 121, a resulting set S₋₁={(M₂, H₂), . . . , (M_{N}, H_{N})} obtained by the deletion processing.

As described above, the prediction unit 104 predicts the objective variable for each of the models stored in the storage unit 121. Therefore, as the maximum number of models increases, the processing load for the prediction increases. On the other hand, if no piece of the history information is stored at any period prior to the period in which the data distribution may considerably change unintendedly and temporarily, a situation that an appropriate model cannot be selected may occur. Considering such a situation, the maximum number of models may be determined while taking account of the condition such as a processing load or the length of the period in which the distribution of data may temporarily change substantially.

The generation unit 111 generates visualization information to be displayed on the display 123 or the like. For example, the generation unit 111 generates attribute information as the visualization information. The attribute information represents attributes of a model (a specified model) identifiable by the identification information contained in a piece of the history information, the piece being specified by the user out of the pieces of the history information stored in the storage unit 121.

For example, the reception unit 103 receives the specified model specified by the user through the input device 122 or the like. In the following description, the specified model is denoted as Mₛ, and the learning history of the model Mₛ as Hₛ.

The attribute information can be any kind of information and is, for example, the following kinds (A1) to (A4) of information.

(A1) the rate of influence on the objective variable with respect to each explanatory variable

(A2) a parameter out of parameters of the specified model, which has changed in the target model selected when the specified model is updated

(A3) periods in which the one or more pieces of input data used to update the specified model have been obtained (history of data periods)

(A4) an inapplicable period in which no input data has been used to update the specified model

For example, the generation unit 111 extracts the explanatory variables that contribute to the prediction of the specified model Mₛ with reference to the parameters of the specified model Mₛ, and generates a list of the extracted explanatory variables as the attribute information (A1).

The generation unit 111 refers to the learning history Hₛ to identify a model immediately before the model Mₛ (a model updated into the model Mₛ). The generation unit 111 compares the parameters of the identified model with the parameters of the specified model Mₛ and obtains parameters having changed. The generation unit 111 generates the attribute information that indicates the parameters having changed (A2).

The generation unit 111 generates, with reference to the learning history Hₛ, the attribute information that indicates the period in which input data used for updating the specified model has been obtained (A3).

The generation unit 111 identifies, with reference to the learning history Hₛ, a blank period in which no input data has been used for updating the specified model, and generates the attribute information by applying the inapplicable period representing the identified blank period to the attribute information (A4).

For normal periods where no unintended considerable change in the data distribution occurs, the newest model (the model trained with the input data for the newest period) is usually selected as the target model. In contrast, there is a possibility that the newest model is not selected for a period where any unintended considerable change in the data distribution has occurred. In such a period, one or more of the newest periods become the blank period in which the corresponding input data is not used for updating a model. In addition, the learning history after the updating of the model becomes a history that does not include the newest one or more periods. In other words, the learning history includes periods that are discontinuous. The generation unit 111 is capable of identifying, as the inapplicable period, the blank period described above.

The display controller 112 controls display (visualization) of various kinds of information on the display 123. For example, the display controller 112 displays, on the display 123, the attribute information (the visualization information) generated by the generation unit 111.

The above-described units (the communication controller 101, the storage controller 102, the reception unit 103, the prediction unit 104, the evaluation unit 105, the selection unit 106, the updating unit 107, the generation unit 111, and the display controller 112) may be implemented by one or more hardware processors. The units may be implemented by causing a processor such as a CPU to execute a computer program, that is, implemented by software. The units may be implemented by a processor such as a dedicated IC, that is, implemented by hardware. The units may be implemented by the combination of software and hardware. When two or more processors are used, each processor may implement any one of the units or implement two or more of the units.

The following mainly describes an example using an information processing system for quality control for manufacturing equipment of a certain product PA. The product PA is a product that is determined to be defective when, for example, the concentration thereof is below a given threshold value. Concentration sensor values detected by a given concentration sensor included in the manufacturing equipment are used for monitoring of the quality of the product PA.

In addition to this concentration sensor, the manufacturing equipment includes various other sensors such as a current sensor, a temperature sensor, and another concentration sensor. In the present embodiment, a model is configured to predict a concentration sensor value (the objective variable) to be monitored by using sensor values from the above-described sensors as input data (the explanatory variables), and then output the predicted concentration sensor value as output data. This model is a model capable of presenting the rate of influence of each piece of the input data on the prediction. For example, analyzing quality-related factors using the rates of influence makes it possible to work on yield improvement. The following presents an example to which the Transfer Lasso (least absolute shrinkage and selection operator) technique is applied as a model training method. The Transfer Lasso technique is described in, for example, “Transfer Learning via $ell_1$ Regularization”, M. Takada et al., Advances in Neural Information Processing Systems (NeurIPS2020), 33, 14266-14277.

FIG. 4 is a flowchart illustrating an example of model estimation processing according to the embodiment. The model estimation processing is used to estimate an initial model from which the updating is started.

The updating unit 107 sets learning parameters to be used by the updating unit 107 and the maximum number of models to be stored in the storage unit 121 (step S101). For example, in the Transfer Lasso technique, regularization parameters and transfer parameters are set as the learning parameters.

The reception unit 103 receives inputs of initial data and a data period from the management system 200 (step S102). The initial data is data D₁=(X₁, Y₁), which includes sensor values acquired in a data period hi (for example, one month). The sensor values are concentration sensor values serving as the objective variable Y₁ and the other sensor values serving as the explanatory variable X₁. The data format of the initial data is the same as the data format of the input data illustrated in FIG. 2, for example.

The updating unit 107 trains a model by using the input data D₁ in accordance with the set learning parameters (step S103). With the Transfer Lasso technique, the updating unit 107 learns coefficients β={β₁, . . . , βₚ} to obtain y=Xβ, where y is a target value and X is the input data for the model. The letter p is the number of the explanatory variables X and the number of elements of coefficients β. Each element of the coefficients β₁, . . . , and βₚ corresponds to the rate of influence of the corresponding explanatory variable (a sensor value of a corresponding sensor such as the current sensor) on the objective variable (a sensor value of the concentration sensor).

In the Transfer Lasso technique, the initial model is learned with a learning method using the Lasso regression. The learned model is set as a new model M₁.

The updating unit 107 treats the learning history on the model M₁ as H₁=[h₁], and stores a piece of history information that includes the model M₁ and the learning history H₁ in the storage unit 121 (step S104). The updating unit 107 further stores the coefficients β={β₁, . . . , βₚ} and respective sensor names corresponding to the coefficients in the storage unit 121 as information (parameters) of the model M₁. An example of the parameters stored in such a manner is illustrated in FIG. 3 mentioned above.

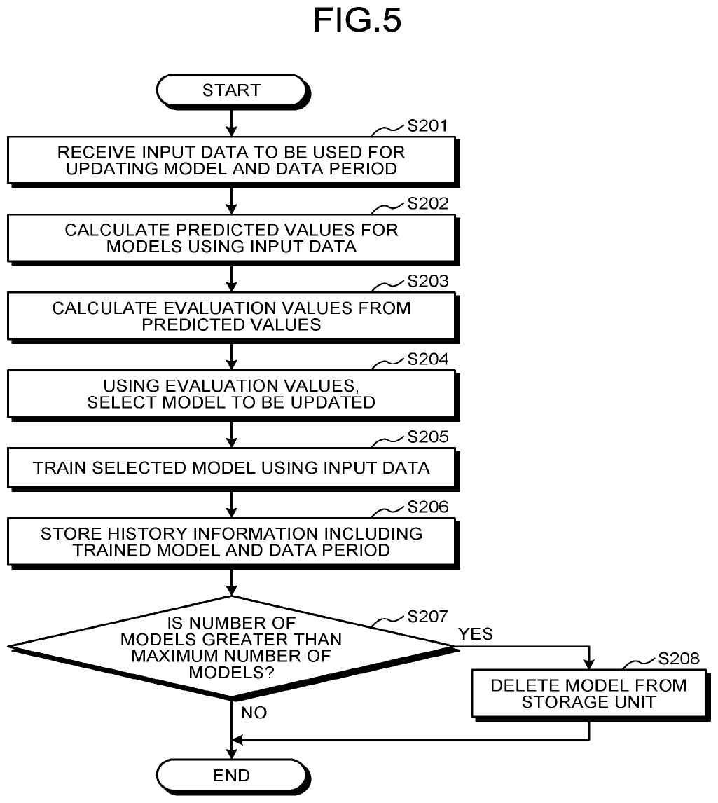

FIG. 5 is a flowchart illustrating an example of model updating processing according to the embodiment. The model updating processing is performed for updating a model starting from the initial model estimated by the processing in FIG. 4. The model updating processing can be iterated further on updated models using input data that are newly acquired.

The reception unit 103 receives input of input data Dₜ to be used for updating a model and a data period hₜ from the management system 200 (step S201). The input data Dₜ is data that has been acquired in the data period hₜ (for example, one month). The input data Dₜ includes concentration sensor values serving as the objective variable Yₜ and the other sensor values serving as the explanatory variable Xₜ.

Next, the prediction unit 104 reads out, from the storage unit 121, all the models M₁, . . . , and M_{N} and the learning histories H₁, . . . , and H_{N} stored in the storage unit 121. The prediction unit 104 calculates predicted values Y\hat{ }ₜ of the objective variable Yₜ, which are respective pieces of output data obtained by inputting the explanatory variable Xₜ to the readout models (step S202). With the Transfer Lasso technique, the predicted value Y\hat{ }ₜ^{k} for the model Mₖ (1≤k≤N) is calculated by Y\hat{ } ₜ^{k}=Xβ^{k}.

Subsequently, the evaluation unit 105 calculates the evaluation value of each of the models by using the predicted value of that model (step S203). For example, when the mean square error of the model is used as the evaluation value, the evaluation unit 105 calculates the evaluation value Eₖ of the model Mₖ using the following formula (1).

Eₖ=∥Yₜ−Ŷₜ^{k}μ₂ (1)

With reference to the evaluation values E₁, . . . , E_{N} of the models M₁, . . . , M_{N}, the selection unit 106 selects, as a target model M_{best} to be updated, the model that corresponds to the best evaluation value (step S204).

The updating unit 107 trains the selected target model by using the input data (step S205). For example, the target model M_{best} and the learning history H_{best} corresponding to the target model M_{best} are input to the updating unit 107 from the selection unit 106. The data Dₜ=(Xₜ, Yₜ) and the data period hₜ are input to the updating unit 107 from the reception unit 103. The updating unit 107 updates a model based on the Transfer Lasso technique using the data Dₜ=(Xₜ, Yₜ) and the model M_{best}, thereby obtaining an updated model M_{new}. The updating unit 107 also updates the learning history into H_{new}=[H_{best}, hₜ].

The storage controller 102 stores, in the storage unit 121, a piece of history information that includes the updated model M_{new} and the learning history H_{new} (step S206).

Subsequently, the storage controller 102 reads out, from the storage unit 121, a set of pieces of history information stored in the storage unit 121. The storage controller 102 determines whether the number of models in the set of pieces of history information read out from the storage unit 121 is larger than the maximum number of models (step S207). The maximum number of models is set, for example, at step S101 of FIG. 4.

When the number of models is larger than the maximum number of models (Yes at step S207), the storage controller 102 deletes the oldest model and the learning history corresponding to the oldest model from the set of pieces of history information, and inputs the resultant set of pieces of history information to the storage unit 121 to replace the set of pieces of history information by the resultant one (step S208).

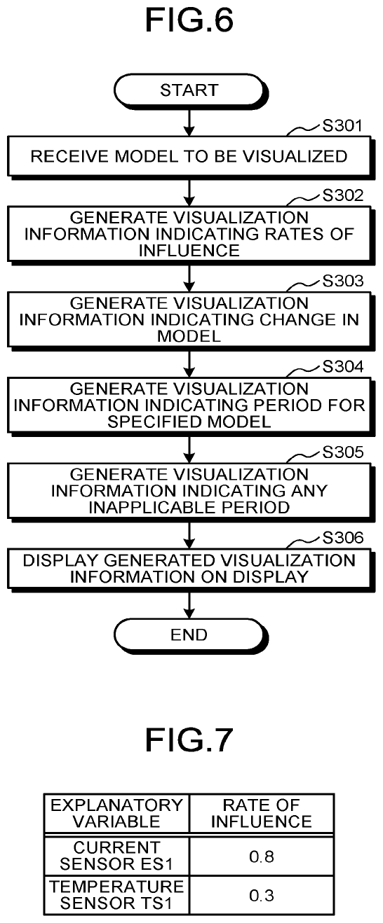

Next, visualization processing is described, where the visualization information (the attribute information) is generated and visualized. FIG. 6 is a flowchart illustrating an example of the visualization processing.

For example, the display controller 112 displays, on the display 123, a selection screen through which a model to be visualized is selected from among the models stored in the storage unit 121. Using the input device 122, the user selects the model to be visualized. In the following, the selected model is denoted as a specified model Mₛ, and the learning history corresponding to the specified model Mₛ is denoted as Hₛ.

The reception unit 103 receives the specified model Mₛ thus selected (specified) (step S301). Thereafter, the attribute information (the visualization information) of the specified model Mₛ is generated by the generation unit 111, and the attribute information is visualized on the display 123 or the like by the display controller 112.

The attribute information is, for example, the information (A1) to (A4) described above. One or more kinds of attribute information to be visualized may be selected by the user or the like from the two or more kinds of attribute information. To visualize the attribute information (A1) to (A4), respective steps S302 to S05 described below are performed. An order in which these steps are executed is not limited to the order illustrated in FIG. 6. Furthermore, some of these steps may be omitted, for example, when there is any kind of attribute information not selected as one to be visualized.

The generation unit 111 generates the visualization information indicating the rates of influence (step S302). For example, the generation unit 111 extracts elements of the explanatory variable that contribute to the prediction of the specified model Mₛ. With the Transfer Lasso technique, the variable elements that contribute to the prediction are those corresponding to coefficients β that are non-zero. The magnitudes (the absolute values) of the coefficients β are the rates of influence.

FIG. 7 illustrates examples of calculated rates of influence. FIG. 7 illustrates examples of calculated rates of influence when parameters of the specified model Mₛ are the coefficients β illustrated in FIG. 3. As illustrated in FIG. 7, it may be unnecessary to calculate the rate of influence for any of the coefficients β having a value of 0.

Returning to FIG. 6, the generation unit 111 generates the visualization information indicating a change of the model (step S303). For example, with reference to the learning history Hₛ on the specified model Mₛ, the generation unit 111 identifies a model Mₛ₋₁, which has been updated into the specified model Mₛ. The generation unit 111 calculates the change of the specified model Mₛ from the model Mₛ₋₁. For models in the Transfer Lasso technique, a change of the model is respective differences between the corresponding coefficients of the specified model Mₛ and the model Mₛ₋₁.

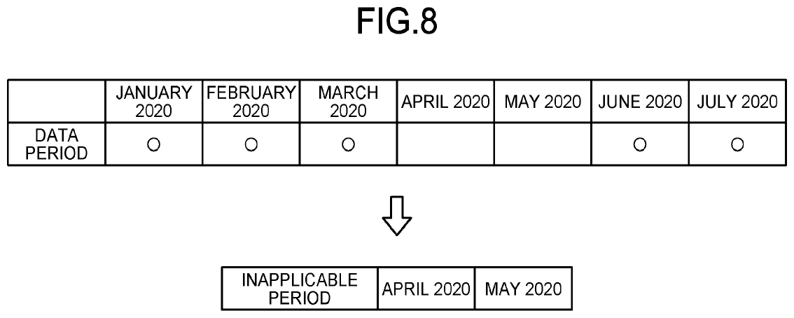

With reference to the learning history Hₛ, the generation unit 111 generates visualization information indicating a period for which input data used to update the specified model Mₛ has been acquired (step S304). The generation unit 111 generates the visualization information that indicates any inapplicable period (step S305). For example, with reference to the learning history Hₛ, the generation unit 111 determines a discontinuous period, and specifies the determined period as an inapplicable period. FIG. 8 illustrates examples of estimated inapplicable periods. In FIG. 8, the data periods for which the symbol “O” is set indicate periods in which input data is obtained. In this example, the generation unit 111 estimates that April 2020 and May 2020 are inapplicable periods.

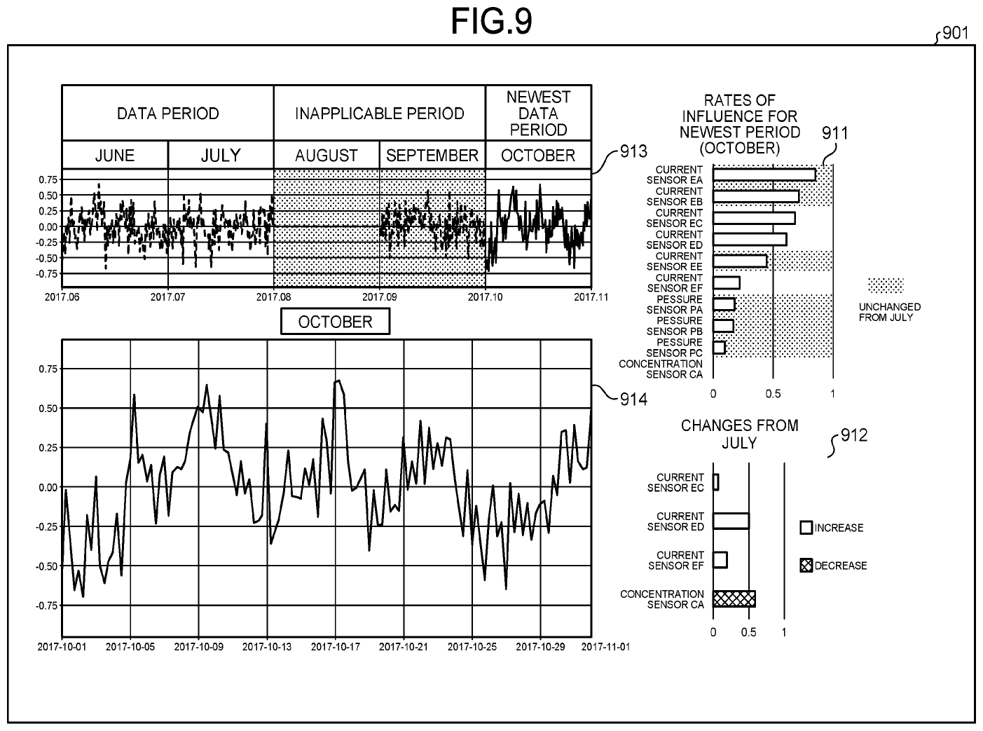

The display controller 112 visualizes the generated visualization information on the display 123 or the like (step S306). FIG. 9 illustrates an example of a display screen 901 displaying visualization information.

A graph 911 represents the rates of influence of individual explanatory variable elements. A graph 912 represents changes in a model during the newest data period (October) from the second newest data period (July). The changes of the model are depicted, for example, as changes in coefficients β for the sensors that correspond to the coefficients β that have changed. A graph 913 represents changes in the objective variable plotted against learning histories (histories of data periods) and inapplicable periods. A graph 914 represents changes in the objective variable for the newest data period.

The display screen 901 in FIG. 9 is one example, and a method of visualizing the visualization information is not limited to this example. For example, only one or more of the graphs illustrated in FIG. 9, which correspond to the attribute information specified by the user or the like, may be visualized.

As described above, the present embodiment allows for easier model validation and factor analysis even when there has been an unintended and temporary considerable change in the distribution of data.

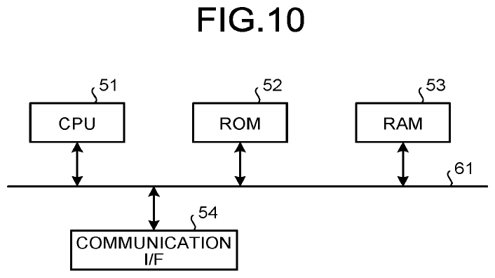

Next, the hardware configuration of an information processing apparatus according to the embodiment is described using FIG. 10. FIG. 10 illustrates an example of the hardware configuration of the information processing apparatus according to the embodiment.

The information processing apparatus according to the embodiment includes a control device such as a CPU 51, a storage device such as a read only memory (ROM) 52 and a random access memory (RAM) 53, a communication interface 54 that connects to a network for communication, and a bus 61 that connects these components to each other.

A computer program to be executed on the information processing apparatus according to the embodiment is provided by being previously embedded in the ROM 52 or the like.

The computer program to be executed by the information processing apparatus according to the embodiment may be configured to be recorded in a non-transitory computer-readable recording medium such as a compact disk read only memory (CD-ROM), a flexible disk (FD), a Compact Disk Recordable (CD-R), a digital versatile disk (DVD) to be provided as a computer program product in an installable or executable format file. Moreover, the computer program to be executed by the information processing apparatus according to the embodiment may also be stored on a computer connected to a network such as the Internet to be provided by having it downloaded via the network. The computer program to be executed by the information processing apparatus according to the embodiment may also be configured to be provided or distributed via a network such as the Internet.

The computer program to be executed by the information processing apparatus according to the embodiment enables a computer to function as the above described components of the information processing apparatus. In this computer, the CPU 51 is capable of reading out a computer program from a computer-readable storage medium onto a main storage device and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
one or more hardware processors configured to:
store, in a memory, one or more pieces of history information each including identification information of a model and a history of updating the model, the model being configured to receive a piece of input data including variables and output a piece of output data, the variables each being a variable for which a rate of influence on the output data is calculated, the model having been updated by using one or more pieces of first input data;
select a target model to be updated by using second input data, the target model being selected from among models identified by their respective identification information included in the one or more pieces of history information; and
update the target model by performing transfer learning in which updated parameters are estimated by using the second input data.

2. The information processing apparatus according to claim 1, wherein
the one or more hardware processors are configured to:
predict the output data by using the second input data, the output data being predicted for each of one or more models identified by their respective identification information included in the one or more pieces of history information;
calculate, for each of the one or more models, an evaluation value indicating accuracy of prediction on the basis of the output data, and
select, as the target model, a model whose evaluation value indicates that the corresponding model has higher accuracy of prediction than the other models.

3. The information processing apparatus according to claim 2, wherein
the one or more models are each a regression model to which a piece of input data is input and from which a piece of output data is output, the piece of input data including a plurality of explanatory variables, the piece of output data being an objective variable, and
the evaluation value is a mean square error, a coefficient of determination, or a mean absolute error.

4. The information processing apparatus according to claim 1, wherein, when the number of pieces of the history information exceeds a threshold value, the one or more hardware processors delete part of the one or more pieces of history information stored in the memory.

5. The information processing apparatus according to claim 1, wherein the one or more hardware processors are configured to:
generate attribute information representing attributes of a specified model being a model identified by a piece of identification information included in a specified piece of the one or more pieces of the history information; and
visualize the attribute information.

6. The information processing apparatus according to claim 5, wherein the one or more hardware processors generate the rates of influence as the attribute information.

7. The information processing apparatus according to claim 5, wherein the one or more hardware processors generate the attribute information indicating one of parameters of the specified model, the one of parameters being a parameter having changed from a parameter of the target model selected when the specified model is updated.

8. The information processing apparatus according to claim 5, wherein
the one or more pieces of history information further include information indicating one or more periods in which the corresponding one or more pieces of first input data used for updating the specified model are acquired, and
the one or more hardware processors generate the attribute information indicating the one or more periods.

9. The information processing apparatus according to claim 5, wherein
the one or more pieces of history information further include information indicating one or more periods in which the corresponding one or more pieces of first input data used for updating the specified model are acquired, and
the one or more hardware processors generate, on the basis of the history information, the attribute information indicating an inapplicable period in which the first input data is not used for updating the specified model.

10. An information processing method implemented by a computer, the method comprising:
storing, in a memory, one or more pieces of history information each including identification information of a model and a history of updating the model, the model being configured to receive a piece of input data including variables and output a piece of output data, the variables each being a variable for which a rate of influence on the output data is calculated, the model having been updated by using one or more pieces of first input data;
selecting a target model to be updated by using second input data, the target model being selected from among models identified by their respective identification information included in the one or more pieces of history information; and
updating the target model by performing transfer learning in which updated parameters are estimated by using the second input data.

11. A computer program product comprising a non-transitory computer-readable recording medium on which a program executable by a computer is recorded, the program instructing the computer to:
store, in a memory, one or more pieces of history information each including identification information of a model and a history of updating the model, the model being configured to receive a piece of input data including variables and output a piece of output data, the variables each being a variable for which a rate of influence on the output data is calculated, the model having been updated by using one or more pieces of first input data;
select a target model to be updated by using second input data, the target model being selected from among models identified by their respective identification information included in the one or more pieces of history information; and
update the target model by performing transfer learning in which updated parameters are estimated by using the second input data.
